(19) United States
(12) Patent Application Publication
(10) Pub. No.: US 2024/0254318 A1
(43) Pub. Date: Aug. 1, 2024

(54) POLYMER COMPOSITION COMPRISING AT LEAST ONE THERMOPLASTIC POLYMER AND FIBRES

(71) Applicant: BASF SE, Ludwigshafen am Rhein (DE)

(72) Inventors: Philippe DESBOIS, Ludwigshafen (DE); Saskia MUEHLUM, Ludwigshafen (DE)

(21) Appl. No.: 18/561,167

(22) PCT Filed: Jun. 9, 2022
(86) PCT No.: PCT/EP22/65706

§ 371 Date: Nov. 15, 2023

(30) Foreign Application Priority Data
Jun. 14, 2021 (EP) 21179305.4

(51) Int. Cl. C08K 7/14; C08J 3/20

(52) U.S. Cl. CPC C08K 7/14; C08J 3/203; C08J 2377/02; C08K 2201/004

(57) ABSTRACT

Disclosed herein is a a polymer composition (PC) including at least one thermoplastic polymer (A) and fibres (B) having a fibre length l. At most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm. Further disclosed herein are a process for producing the polymer composition (PC), a process for producing a moulded article by forming the polymer composition (PC) and a moulded article including the polymer composition (PC). Additionally disclosed herein is a method of using fibres (B) for increasing the toughness and/or reinforcement of moulded articles made from the polymer composition (PC).

The present invention relates to a polymer composition (PC) comprising at least one thermoplastic polymer (A) and fibres (B) having a fibre length l. At most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm. The present invention further relates to a process for producing the inventive polymer composition (PC), to a process for the production of a moulded article by forming the inventive polymer composition (PC) and to a moulded article comprising the inventive polymer composition (PC). In addition, it relates to the use of fibres (B) having a fibre length l in a polymer composition (PC) comprising at least one thermoplastic polymer (A) for increasing the toughness and/or reinforcement of moulded articles made from said polymer composition (PC), wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm.

Thermoplastic polymers in general are polymers that are of particular importance industrially because of their very good mechanical properties. In particular, they possess high strength, stiffness, and toughness, good chemical resistance, and a high abrasion resistance and tracking resistance. These properties are particularly important for the production of (injected-) moulded articles, wherein a polymer composition, comprising these thermoplastic polymers, is formed to obtain the (injected-) moulded articles.

To further improve the properties of (injected-) moulded articles, fibres are often added to the polymer composition. During the production of the polymer composition, therefore, usually chopped fibres or ground fibres are added to the thermoplastic polymer prior to extrusion. After extrusion, the fibres are present in a broad length distribution in the polymer composition. For example, after the use of chopped fibres, fibres with a length distribution of less than 20 to greater than 1000 μm and an average value of 300 μm are present, and when milled fibres are used, fibres with a similar length distribution and an average value of 100 μm are present, for example. However, an excessively high proportion of short-fibres with a length of less than 200 μm has a negative effect on the mechanical properties of the mouldings, for example, the reinforcing effect is reduced.

US 2016/0272788 A1 discloses a thermoplastic molding composition, in particular a polyamide molding composition, consisting of, by weight: 20 to 88% of a thermoplastic material (A), 10 to 60% of fibrous fillers (B), 2 to 10% of a laser direct structuring additive (LDS additive) or a mixture of laser direct structuring additives (C) and optionally particulate filler (D) and/or further different additives (E).

U.S. Pat. No. 10,233,326 B2 discloses a polyamide molding compound, comprising a blend of a) 50 to 90 parts by weight of at least one polyamide represented by the formula “5X” and 10 to 50 parts by weight of at least one partially aromatic polyamide and c) 10 to 250 parts by weight of fibres, wherein the fibres c) are glass fibres with non-circular cross-section.

US 2014/0296414 A1 discloses a carbon fiber-reinforced thermoplastic resin composition, comprising: a thermoplastic resin (A); a carbon fiber (B); and a titanium compound (C), an amount of the thermoplastic resin (A) being 10 to 65% by weight, an amount of the carbon fiber (B) being 35 to 90% by weight, based on 100% by weight of the total amount of the thermoplastic resin (A) and the carbon fiber (B), and an amount of the titanium compound (C) being 0.01 to 5 parts by weight, based on 100 parts by weight of the total amount of the thermoplastic resin (A) and the carbon fiber (B).

It is therefore an object of the present invention to provide an improved polymer composition from which it is possible to produce moulded articles with good mechanical properties in a very simple and inexpensive manner.

This object is achieved in accordance with the invention by a polymer composition (PC) comprising the following components (A) and (B)
(A) at least one thermoplastic polymer and
(B) fibres having a fibre length l,

wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm.

Further, it is achieved by a process for producing a polymer composition (PC) comprising the following steps a) and b)
a) providing fibres (B′) having a defined fibre length 11 in the range from 200 to 600 μm, and
b) compounding the fibres (B′) with at least one thermoplastic polymer (A) in an extruder, wherein the polymer composition (PC) comprising the at least one thermoplastic polymer (A) and the fibres (B) having a fibre length l is obtained, wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm.

Surprisingly, it has been found that by compounding fibres (B′) having a defined fibre length 11 in the range from 200 to 600 μm with at least one thermoplastic polymer (A) in an extruder, a polymer composition (PC) comprising the at least one thermoplastic polymer (A) and fibres (B) having a fibre length l is obtained, wherein at most 10% by weight, preferably at most 5% by weight, more preferably at most 4% by weight, of the fibres (B), based on the total weight of the fibres (B), have a fibre length l of less than 100 μm, and at most 12% by weight, of the fibres (B), based on the total weight of the fibres (B), have a fibre length l of less than 200 μm. Furthermore, it has been found that, preferably, the fibres (B) have a monomodal fibre length distribution with a maximum (M), wherein the maximum (M) is a value (V) in the range from 200 to 600 μm, wherein at least 35% by weight of the fibres (B), based on the total weight of the fibres (B), have a fibre length l of this value (V) with a standard deviation of +0.1×l, and/or the fibres (B) have a monomodal fibre length distribution with a maximum (M), wherein the maximum (M) is a value (V) in the range from 200 to 600 μm, wherein at least 50% by weight of the fibres (B), based on the total weight of the fibres (B), have a fibre length l of this value (V) with a standard deviation of +0.25×l.

In addition, it has been surprisingly found that the use of these fibres (B) having a fibre length l in a polymer composition (PC) comprising at least one thermoplastic polymer (A), wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm, increases the toughness and/or reinforcement of the moulded articles made from said polymer composition (PC). Additionally, it has been found that the use of these fibres (B) in the polymer composition (PC) reduces the brittleness of the moulded articles.

The polymer composition (PC) according to the invention, as well as the process for its production, is more particularly elucidated herein below.

### Polymer Composition (PC)

According to the invention the polymer composition (PC) comprises at least one thermoplastic polymer (A) and fibres (B) having a fibre length l.

In the context of the present invention “at least one thermoplastic polymer (A)” is to be understood as meaning either precisely one thermoplastic polymer (A) or else a mixture of two or more thermoplastic polymers (A).

The term “fibres (B) having a fibre length l” is to be understood as meaning that the polymer composition (PC) either comprises fibres (B) of precisely one type of fibres having a fibre length l or else a mixture of two or more types of fibres (B) having a fibre length l.

Examples of types of fibres are fibres selected from the group consisting of glass fibres, basalt fibres, carbon fibres, metal fibres and plastic fibres, and/or fibres selected from the group consisting of hollow fibres and flat fibres.

The polymer composition (PC) may comprise the at least one thermoplastic polymer (A) and the fibres (B) having a fibre length l in any desired amounts.

It is preferable when the polymer composition (PC) comprises in the range from 30 to 90% by weight of the at least one thermoplastic polymer (A) and in the range from 10 to 70% by weight of fibres having a fibre length l (B), based in each case on the sum of the weight percentages of component (A) and component (B), preferably based in each case on the total weight of the polymer composition (PC).

It is particularly preferable when the polymer composition (PC) comprises in the range from 40 to 80% by weight of the at least one thermoplastic polymer (A) and in the range from 20 to 60% by weight of fibres having a fibre length l (B), based in each case on the sum of the weight percentages of component (A) and component (B), preferably based in each case on the total weight of the polymer composition (PC).

It is most preferable when the polymer composition (PC) comprises in the range from 50 to 75% by weight of the at least one thermoplastic polymer (A) and in the range from 25 to 50% by weight of fibres having a fibre length l (B), based in each case on the sum of the weight percentages of component (A) and component (B), preferably based in each case on the total weight of the polymer composition (PC).

The present invention thus also provides a polymer composition (PC) in which the polymer composition (PC) comprises in the range from 30 to 90% by weight of component (A) and in the range from 10 to 70% by weight of component (B), based in each case on the total weight of the polymer composition (PC).

The polymer composition (PC) may further comprise at least one additive (C) in addition to the at least one thermoplastic polymer (A) and the fibres having a fibre length l (B).

In the context of the present invention, “at least one additive (C)” is to be understood as meaning either precisely one additive (C) or else a mixture of two or more additives (C). The at least one additive (C) is preferably selected from the group consisting of stabilizers, dyes, pigments and plasticizers.

The polymer composition (PC) may comprise, for example, in the range from 0 to 1% by weight of the at least one additive (C), based on the total weight of the polymer composition (PC). It is preferable when the polymer composition (PC) comprises in the range from 0.01 to 1% by weight, more preferably in the range from 0.02 to 1% by weight, and especially preferably in the range from 0.04 to 1% by weight, of the at least one additive (C), in each case based on the sum of the weight percentages of the at least one thermoplastic polymer (A), the fibres having a fibre length l (B) and the at least one additive (C), preferably based on the total weight of the polymer composition (PC).

It will be appreciated that, when the polymer composition (PC) comprises at least one additive (C), the % by weight values of the at least one thermoplastic polymer (A) present in the polymer composition (PC) are correspondingly reduced so that the sum of the % by weight values of the at least one thermoplastic polymer (A), of the fibres having a fibre length l (B) and of the at least one additive (C) sum to 100%.

In case the polymer composition (PC) comprises at least one additive (C), the polymer composition (PC) comprises, for example, in the range from 29 to 89.99% by weight of the at least one thermoplastic polymer (A), in the range from 10 to 70% by weight of the fibres having a fibre length l (B) and in the range from 0.01 to 1% by weight of the at least one additive (C), in each case based on the sum of the weight percentages of the at least one thermoplastic polymer (A), the fibres having a fibre length l (B) and the at least one additive (C), preferably based in each case on the total weight of the polymer composition (PC).

The present invention thus also provides a polymer composition (PC) in which the polymer composition (PC) comprises in the range from 29 to 89.99% by weight of component (A), in the range from 10 to 70% by weight of component (B) and in the range from 0.01 to 1% by weight of component (C), based in each case on the total weight of the polymer composition (PC).

The polymer composition (PC) may further comprise at least one flame retardant (D) in addition to the at least one thermoplastic polymer (A) and the fibres having a fibre length l (B), and optionally, to the at least one additive (C).

In the context of the present invention, “at least one flame retardant (D)” is to be understood as meaning either precisely one flame retardant (D) or else a mixture of two or more flame retardants (D).

The polymer composition (PC) may comprise, for example, in the range from 0 to 25% by weight of the at least one flame retardant (D), based on the total weight of the polymer composition (PC). It is preferable when the polymer composition (PC) comprises in the range from 0.01 to 25% by weight, more preferably in the range from 0.02 to 25% by weight, and especially preferably in the range from 0.04 to 15% by weight, of the at least one flame retardant (D), in each case based on the sum of the weight percentages of the at least one thermoplastic polymer (A), the fibres having a fibre length l (B), the at least one flame retardant (D), and optionally, the at least one additive (C), preferably in each case based on the total weight of the polymer composition (PC).

It will be appreciated that, when the polymer composition (PC) comprises at least one flame retardant (D), the % by weight values of the at least one thermoplastic polymer (A) present in the polymer composition (PC) are correspondingly reduced so that the sum of the % by weight values of the at least one thermoplastic polymer (A), of the fibres having a fibre length l (B), of the at least one flame retardant (D), and optionally, of the at least one additive (C) sum to 100%.

The polymer composition (PC) may further comprise at least one impact modifier (E) in addition to the at least one thermoplastic polymer (A) and the fibres having a fibre length l (B), and optionally, to the at least one additive (C) and the at least one flame retardant (D).

In the context of the present invention, “at least one impact modifier (E)” is to be understood as meaning either precisely one impact modifier (E) or else a mixture of two or more impact modifiers (E).

The polymer composition (PC) may comprise, for example, in the range from 0 to 95% by weight of the at least one impact modifier (E), based on the total weight of the polymer composition (PC). It is preferable when the polymer composition (PC) comprises in the range from 0 to 70% by weight, more preferably in the range from 0 to 50% by weight, of the at least one impact modifier (E), in each case based on the sum of the weight percentages of the at least one thermoplastic polymer (A), the fibres having a fibre length l (B), the at least one impact modifier (E), and, optionally, the at least one flame retardant (D) and the at least one additive (C), preferably in each case based on the total weight of the polymer composition (PC).

It will be appreciated that, when the polymer composition (PC) comprises at least one impact modifier (E), the % by weight values of the at least one thermoplastic polymer (A) present in the polymer composition (PC) are correspondingly reduced so that the sum of the % by weight values of the at least one thermoplastic polymer (A), of the fibres having a fibre length l (B), of the at least one impact modifier (E), and, optionally, the at least one flame retardant (D), and the at least one additive (C) sum to 100%.

### Thermoplastic Polymer (Component (A))

The polymer composition (PC) comprises at least one thermoplastic polymer (A).

Suitable thermoplastic polymers (A) are selected from the group consisting of polyamides, polyesters, polycarbonates, polyolefins, polyurethanes, polyethers, polysulfones, polyacrylates, polymethacrylates, polystyrenes and polyoxymethylene.

Thus, the present invention also provides a polymer composition (PC) in which the at least one thermoplastic polymer (A) is selected from the group consisting of polyamides, polyesters, polycarbonates, polyolefins, polyurethanes, polyethers, polysulfones, polyacrylates, polymethacrylates, polystyrenes and polyoxymethylene.

Suitable polyamides (A) generally have a viscosity number of 70 to 350 ml/g, preferably of 70 to 240 ml/g. The viscosity number is determined according to the invention from a 0.5 wt % solution of the polyamide (A) in 96 wt % sulfuric acid at 25° C. according to ISO 307.

Preferred polyamides (A) are semicrystalline polyamides. Suitable polyamides (A) have a weight-average molecular weight (Mw) in the range from 500 to 2 000 000 g/mol, preferably in the range from 5 000 to 500 000 g/mol and particularly preferably in the range from 10 000 to 100 000 g/mol. The weight-average molecular weight (Mw) is determined according to ASTM D4001.

Suitable polyamides (A) include for example polyamides (A) which derive from lactams having 7 to 13 ring members. Suitable polyamides (A) further include polyamides (A) obtained by reaction of dicarboxylic acids with diamines.

Examples of polyamides (A) which derive from lactams include polyamides which derive from polycaprolactam, polycaprylolactam and/or polylaurolactam.

Suitable polyamides (A) further include those obtainable from ω-aminoalkyl nitriles. A preferred ω-aminoalkylnitrile is aminocapronitrile which results in polyamide 6. Furthermore, dinitriles may be reacted with diamine. Preference is given here to adipodinitrile and hexamethylenediamine which polymerize to afford polyamide 66. The polymerization of nitriles is effected in the presence of water and is also known as direct polymerization.

When polyamides (A) obtainable from dicarboxylic acids and diamines are used, dicarboxylic acid alkanes (aliphatic dicarboxylic acids) having 4 to 36 carbon atoms, preferably 6 to 12 carbon atoms and particularly preferably 6 to 10 carbon atoms may be employed. Aromatic dicarboxylic acids are also suitable.

Examples of dicarboxylic acids include adipic acid, azelaic acid, sebacic acid, dodecanedioic acid and also terephthalic acid and/or isophthalic acid.

Suitable diamines include for example alkanediamines having 4 to 36 carbon atoms, preferably alkanediamines having 6 to 12 carbon atoms, in particular alkanediamines having 6 to 8 carbon atoms, and aromatic diamines, for example, m-xylylenediamine, di(4-aminophenyl)methane, di(4-aminocyclohexyl)methane, 2,2-di(4-aminophenyl)-propane, 2,2-di(4-aminocyclohexyl)propane and 1,5-diamino-2-methylpentane.

Preferred polyamides (A) are polyhexamethylene adipamide, polyhexamethylene sebacamide and polycaprolactam and also copolyamide 6/66, in particular having a proportion of caprolactam units of 5 to 95 wt %.

Also suitable are polyamides (A) obtainable by copolymerization of two or more of the monomers mentioned hereinabove and hereinbelow or mixtures of a plurality of polyamides (A) in any desired mixing ratio. Particularly preferred mixtures are mixtures of polyamide 66 with other polyamides (A), in particular copolyamide 6/66.

Suitable polyamides (A) are accordingly aliphatic, semiaromatic or aromatic polyamides (A). The term “aliphatic polyamides” is to be understood as meaning that the polyamides (A) are constructed exclusively from aliphatic monomers. The term “semiaromatic polyamides” is to be understood as meaning that the polyamides (A) are constructed from both aliphatic and aromatic monomers. The term “aromatic polyamides” is to be understood as meaning that the polyamides (A) are constructed exclusively from aromatic monomers.

The no exhaustive list which follows comprises the abovementioned, and further, polyamides (A) suitable for use in the process according to the invention and the monomers present.

AB polymers:

| | |
|---|---|
| PA 4 | pyrrolidone |
| PA 6 | ε-caprolactam |
| PA 7 | enantholactam |
| PA 8 | caprylolactam |
| PA 9 | 9-aminopelargonic acid |
| PA 11 | 11-aminoundecanoic acid |
| PA 12 | laurolactam |

AA/BB polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 1010 | decane-1,12-diamine, sebacic acid |
| PA 1212 | dodecane-1,12-diamine, decanedicarboxylic acid |
| PA 1313 | tridecane-1,13-diamine, undecanedicarboxylic acid |
| PA 4T | tetramethylenediamine, terephthalic acid |
| PA 6T | hexamethylenediamine, terephthalic acid |
| PA 9T | nonyldiamine, terephthalic acid |
| PA MXD6 | m-xylylenediamine, adipic acid |
| PA 6I | hexamethylenediamine, isophthalic acid |
| PA 6-3-T | trimethylhexamethylenediamine, terephthalic acid |
| PA 6/6T | (see PA 6 and PA 6T) |
| PA 6T/66 | (see PA 6T and PA 66) |
| PA 6/66 | (see PA 6 and PA 66) |
| PA 66/6 | (see PA 66 and PA 6) |
| PA 6/12 | (see PA 6 and PA 12) |
| PA 66/6/610 | (see PA 66, PA 6 and PA 610) |
| PA 6I/6T | (see PA 6I and PA 6T) |
| PA 6T/61 | (see PA 6T and PA6I) |
| PA 6T/61/66 | (see PA 6T, PA6I and PA 66) |
| PA PACM 12 | diaminodicyclohexylmethane, laurolactam |
| PA 6I/6T/PACM | as PA 6I/6T and diaminodicyclohexylmethane |
| PA 12/MACMI | laurolactam, dimethyldiaminodicyclohexylmethane, |
| | isophthalic acid |
| PA 12/MACMT | laurolactam, dimethyldiaminodicyclohexylmethane, |
| | terephthalic acid |
| PA PDA-T | phenylenediamine, terephthalic acid |

In a preferred embodiment, the at least one polyamide (A) is selected from the group consisting of polyamide 6 (PA 6), polyamide 66 (PA 66), polyamide 6/66 (PA 6/66), polyamide 66/6 (PA 66/6), polyamide 610 (PA 610), polyamide 6/6T (PA 6/6T), polyamide 6T/61 (PA 6T/61), polyamide 12 (PA 12), polyamide 4T (PA 4T), polyamide 9T (PA 9T), polyamide 46 (PA 46), polyamide 1010 (PA 1010) and polyamide 1212 (PA 1212).

Thus, the present invention also provides a polymer composition (PC) in which the at least one thermoplastic polymer (A) is a polyamide selected from the group consisting of polyamide 6 (PA 6), polyamide 66 (PA 66), polyamide 6/66 (PA 6/66), polyamide 66/6 (PA 66/6), polyamide 610 (PA 610), polyamide 6/6T (PA 6/6T), polyamide 6T/61 (PA 6T/61), polyamide 12 (PA 12), polyamide 4T (PA 4T), polyamide 9T (PA 9T), polyamide 46 (PA 46), polyamide 1010 (PA 1010) and polyamide 1212 (PA 1212).

Suitable polyesters are, for example, polybutylene terephthalate (PBT) and polyethylene terephthalate (PET). Suitable polyolefins are, for example, polypropylene (PP), high-density polyethylene (HDPE), low-density polyethylene (LDPE) and their copolymers. A suitable polyurethane is, for example, thermoplastic polyurethane (TPU). A suitable polyether is, for example, propylene oxide (PPO). Suitable polysulfones are, for example, polyether sulfone (PES), polysulfone (PSU) and polyphenylene sulfone (PPSU).

### Fibres Having a Fibre Length l (Component (B))

The polymer composition (PC) comprises fibres having a fibre length l (B). At most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm.

Preferably, at most 5% by weight of the fibres (B), more preferably, at most 4% by weight of the fibres (B), based on the total weight of the fibres (B), have a fibre length l of less than 100 μm.

Thus, the present invention also provides a polymer composition (PC) in which at most 5% by weight of the fibres (B), based on the total weight of the fibres (B), have a fibre length l of less than 100 μm.

Furthermore, at least 1% by weight of the fibres (B), based on the total weight of the fibres (B), have a fibre length l of less than 100 μm, and at least 1% by weight of the fibres (B), based on the total weight of the fibres (B), have a fibre length l of less than 200 μm.

In a preferred embodiment, from 1 to 10% by weight, preferably from 1 to 5% by weight, more preferably from 1 to 4% by weight, of the fibres (B), based on the total weight of the fibres (B), have a fibre length l of less than 100 μm, and from 1 to 12% by weight of the fibres (B), based on the total weight of the fibres (B), have a fibre length l of less than 200 μm.

Thus, the present invention also provides a polymer composition (PC) in which from 1 to 10% by weight, preferably from 1 to 5% by weight, of the fibres (B), based on the total weight of the fibres (B), have a fibre length l of less than 100 μm, and from 1 to 12% by weight of the fibres (B), based on the total weight of the fibres (B), have a fibre length l of less than 200 μm.

In a preferred embodiment, the fibres (B) have a monomodal fibre length distribution.

In the context of the present invention, the term “a monomodal fibre length distribution” means that the fibre length distribution within the fibres (B) according to the present invention has only one maximum, preferably with a defined variance.

However, it is also possible that the fibre length distribution has a higher modality, for example, the fibre length distribution can be bimodal, trimodal or tetramodal, which means that the fibre length distribution within the fibres (B) has two, three or four, maxima, respectively.

Unless indicated otherwise, according to the present invention the fibre lengths and the maxima, respectively, are determined/measured by an Epson perfection V850 Pro flatbed scanner, wherein the fibres are dispersed in a mixture of water and 1 to 2 drops of glycerin, and transferred to a petri dish, which is placed on the surface of the scanner.

In a preferred embodiment, the fibres (B) have a monomodal fibre length distribution with a maximum (M), wherein the maximum (M) is a value (V) in the range from 200 to 600 μm, preferably in the range from 350 to 600 μm.

It is further preferred that the fibres (B) have a monomodal fibre length distribution with a maximum (M), wherein the maximum (M) is a value (V) in the range from 200 to 600 μm, preferably in the range from 350 to 600 μm, wherein at least 35% by weight, preferably at least 40% by weight, of the fibres (B), based on the total weight of the fibres (B), have a fibre length l of this value (V) with a standard deviation of +0.1×l.

Thus, the present invention also provides a polymer composition (PC) in which the fibres (B) have a monomodal fibre length distribution with a maximum (M), wherein the maximum (M) is a value (V) in the range from 200 to 600 μm, wherein at least 35% by weight of the fibres (B), based on the total weight of the fibres (B), have a fibre length l of this value (V) with a standard deviation of ±0.1×l.

It is further preferred that the fibres (B) have a monomodal fibre length distribution with a maximum (M), wherein the maximum (M) is a value (V) in the range from 200 to 600 μm, preferably in the range from 350 to 600 μm, wherein at least 50% by weight, preferably at least 65% by weight, of the fibres (B), based on the total weight of the fibres (B), have a fibre length l of this value (V) with a standard deviation of +0.25×l.

Thus, the present invention also provides a polymer composition (PC) in which the fibres (B) have a monomodal fibre length distribution with a maximum (M), wherein the maximum (M) is a value (V) in the range from 200 to 600 μm, wherein at least 50% by weight of the fibres (B), based on the total weight of the fibres (B), have a fibre length l of this value (V) with a standard deviation of ±0.25×l.

In the context of the present invention, the term “maximum (M)” means the fibre length that appears most often in the measured fibre length distribution.

In the context of the present invention, the term “standard deviation” means the measure of the variation of values of the length around the maximum (M). The standard deviation is determined/measured by an Epson perfection V850 Pro flatbed scanner, wherein the fibres are dispersed in a mixture of water and 1 to 2 drops of glycerin, and transferred to a petri dish, which is placed on the surface of the scanner.

The fibres (B) are preferably selected from the group consisting of glass fibres, basalt fibres, carbon fibres, metal fibres and plastic fibres, more preferably from glass fibres, most preferably selected from the group consisting of E-glass fibres, S-glass fibres, R-glass fibres, M-glass fibres, C-glass fibres, ECR-glass fibres, D-glass fibres, AR-glass fibres and Q-glass fibres.

Therefore, the present invention also provides a polymer composition (PC) in which the fibres (B) are selected from the group consisting of glass fibres, basalt fibres, carbon fibres, metal fibres and plastic fibres, preferably from glass fibres, more preferably selected from the group consisting of E-glass fibres, S-glass fibres, R-glass fibres, M-glass fibres, C-glass fibres, ECR-glass fibres, D-glass fibres, AR-glass fibres and Q-glass fibres.

The fibres (B) can be hollow fibres and flat fibres.

Therefore, the present invention also provides a polymer composition (PC) in which the fibres (B) are selected from the group consisting of hollow fibres and flat fibres.

In case the fibres (B) are glass fibres, the glass fibres have a diameter in the range from 5 to 30 μm.

Therefore, the present invention also provides a polymer composition (PC) in which the glass fibres have a diameter in the range from 5 to 30 μm.

The polymer composition (PC) comprises, for example, in the range from 10 to 70% by weight, preferably in the range from 20 to 60% by weight, most preferably in the range from 25 to 50% by weight, of the fibres (B), based in each case on the sum of the weight percentages of component (A) and component (B), preferably based in each case on the total weight of the polymer composition (PC).

Additive (component (C))

In one embodiment, the polymer composition (PC) also comprises at least one additive (C). The at least one additive (C) is preferably selected from the group consisting of stabilizers, dyes, pigments and plasticizers.

Thus, the present invention also provides a polymer composition (PC) in which the polymer composition (PC) further comprises at least one additive (C) selected from the group consisting of stabilizers, dyes, pigments and plasticizers.

Suitable stabilizers are, for example, phenol, talc, alkaline earth metal silicates, sterically hindered phenols, phosphites and alkaline earth metal glycerophosphates.

Suitable dyes and pigments are, for example, transition metal oxides or nigrosins.

Suitable plasticizers are, for example, dioctyl phthalate, dibenzyl phthalate, butyl benzyl phthalate, hydrocarbon oils, N-(n-butyl)-benzenesulfonamide and ortho- and para-tolylethylsulfonamide.

In case the polymer composition (PC) comprises at least one additive (C), the polymer composition (PC) comprises, for example, in the range from 0.01 to 1% by weight, preferably in the range from 0.02 to 1% by weight, most preferably in the range from 0.04 to 1% by weight, of the at least one additive (C), in each case based on the sum of the weight percentages of the at least one thermoplastic polymer (A), the fibres having a fibre length l (B) and the at least one additive (C), preferably based in each case on the total weight of the polymer composition (PC).

### Flame Retardant (Component (D))

In one embodiment, the polymer composition (PC) also comprises at least one flame retardant (D).

Suitable flame retardants are, for example, melamine cyanurate, aluminium derivatives, magnesium derivatives and halogenides.

In case the polymer composition (PC) comprises at least one flame retardant (D), the polymer composition (PC) comprises, for example, in the range from 0.01 to 25% by weight, preferably in the range from 0.02 to 25% by weight, most preferably in the range from 0.04 to 15% by weight, of the at least one flame retardant (D), in each case based on the sum of the weight percentages of the at least one thermoplastic polymer (A), the fibres having a fibre length l (B), the at least one flame retardant (D) and optionally, the at least one additive (C), preferably based in each case on the total weight of the polymer composition (PC).

Impact modifier (component (E))

In one embodiment, the polymer composition (PC) also comprises at least one impact modifier (E).

Suitable impact modifiers are, for example, polymers based on ethylene propylene (EPM) or ethylene propylene diene (EPDM) rubbers or thermoplastic urethanes and also ionomers or styrene-based rubbers.

In case the polymer composition (PC) comprises at least one impact modifier (E), the polymer composition (PC) may comprise, for example, in the range from 0 to 95% by weight of the at least one impact modifier (E), based on the total weight of the polymer composition (PC). It is preferable when the polymer composition (PC) comprises in the range from 0 to 70% by weight, more preferably in the range from 0 to 50% by weight, of the at least one impact modifier (E), in each case based on the sum of the weight percentages of the at least one thermoplastic polymer (A), the fibres having a fibre length l (B), the at least one impact modifier (E), and, optionally, the at least one flame retardant (D) and the at least one additive (C), preferably in each case based on the total weight of the polymer composition (PC)

### Process for Producing the Polymer Composition (PC)

A further object of the present invention is a process for producing the inventive polymer composition (PC) comprising the following steps a) and b)
a) providing fibres (B′) having a defined fibre length 11 in the range from 200 to 600 μm, and
b) compounding the fibres (B′) with at least one thermoplastic polymer (A) in an extruder, wherein the polymer composition (PC) comprising the at least one thermoplastic polymer (A) and the fibres (B) having a fibre length l is obtained, wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm.

### Step a)

In step a), fibres (B′) having a defined fibre length 11 in the range from 200 to 600 μm, preferably in the range from 350 to 600 μm, are provided.

In the context of the present invention, the term “defined fibre length 11” means that the provided fibres (B′) predominantly have a concrete length value, not a length distribution, which means that at least 90% by weight of the fibres (B′), more preferably at least 95% by weight, and most preferably at least 99% by weight, have a concrete length value in the range from 200 to 600 μm. For example, at least 90% by weight of the fibres (B′) have a fibre length of 350 μm.

The fibres (B′) are preferably selected from the group consisting of glass fibres, basalt fibres, carbon fibres, metal fibres and plastic fibres, more preferably from glass fibres, most preferably selected from the group consisting of E-glass fibres, S-glass fibres, R-glass fibres, M-glass fibres, C-glass fibres, ECR-glass fibres, D-glass fibres, AR-glass fibres and Q-glass fibres. The fibres (B) can be hollow fibres and flat fibres.

The fibres (B′) may be provided by any method known to those skilled in the art.

In a preferred embodiment, the fibres (B′) are provided by cutting a fibre roving (R) into fibres (B′). Preferably, the fibre roving (R) is cut by a cutting machine. An example for a suitable cutting machine is the Guillotine cutting machine P26 manufactured by the company Pierret Industries, Belgium.

Thus, the present invention also provides a process in which the fibres (B′) are provided by cutting a fibre roving (R) into fibres (B′).

Thereby, it is possible to use any fibre roving (R) known to those skilled in the art. However, in a preferred embodiment, the fibre roving (R) is a fibre glass roving.

The fibres (B′) can also be provided by other mechanical commuting methods. For example, the fibres (B′) can be provided by grinding and subsequent length fraction separation. It is also possible to provide the fibres (B′) by chopping. Further possible methods are Guillotine cutting, edge to edge cutting and scissor cutting.

However, it is also possible to provide the fibres (B′) by non-mechanical methods. In addition, it is also possible that a pre-treated fibre roving is directly compounded with at least one thermoplastic polymer (A) in an extruder and that, during compounding, the polymer composition (PC) comprising the at least one thermoplastic polymer (A) and the fibres (B) having a fibre length l is obtained.

### Step b)

In step b), the fibres (B′) are compounded with the at least one thermoplastic polymer (A) in an extruder, wherein the polymer composition (PC) comprising the at least one thermoplastic polymer (A) and the fibres (B) having a fibre length l is obtained, wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm.

Processes for compounding are known to those skilled in the art.

To obtain the polymer composition (PC), the temperature of the extruder during the compounding of the components (A), (B), and optionally (C), can be any temperature and is usually in the range from 200 to 350° C., preferably in the range from 220 to 330° C. and particularly preferably in the range from 240 to 310° C.

The barrel temperature of the extruder can be higher than the temperature of the components in the extruder, and it is equally possible that the barrel temperature of the extruder is lower than the temperature of the components in the extruder. By way of example, it is possible that the barrel temperature of the extruder is initially higher than the temperature of the components in the extruder when the components are being heated. When the components in the extruder are being cooled, it is possible that the barrel temperature of the extruder is lower than the temperature of the components in the extruder.

The temperatures given in the present invention and referring to the extruder are meant to be barrel temperatures of the extruder. “Barrel temperature of the extruder” means the temperature of the barrel of the extruder. The barrel temperature of the extruder is therefore the temperature of the external wall of the extruder barrel. As extruder, any extruder known to the skilled person is suitable which can be used at the temperatures and pressures during the compounding. In general, the extruder can be heated to at least the temperature, at which the at least one thermoplastic polymer (A), the fibres (B′), and, optionally, the at least one additive (C) and/or the at least one flame retardant (D) are compounded. For example, single-screw extruders, twin-screw extruders or multiple-screw extruders are used. In the inventive process, preferably a twin-screw extruder or a multiple-screw extruder is used. Twin-screw extruders are also known as double screw extruders. The twin-screw extruders may be co-rotating or counter-rotating. Extruders are known to the skilled person and are for example described in C. Rauwendaal: Polymer extrusion, Carl Hanser Verlag Gmbh & Co. KG, 5th edition (16 Jan. 2014).

The extruder may also comprise further devices, for example mixing elements or kneading elements. Mixing elements serve for the mixing of the individual components comprised in the extruder. Suitable mixing elements are known to the skilled person and are, by way of example, static mixing elements or dynamic mixing elements. Kneading elements likewise serve for the mixing of the individual components comprised in the extruder. Suitable kneading elements are known to the person skilled in the art and are, by way of example, kneading screws or kneading blocks, for example disk kneading blocks or shoulder kneading blocks. The components (A), (B), and optionally (C) can be added to the extruder in succession or concurrently and are mixed and compounded in the extruder to obtain the polymer composition (PC).

The obtained polymer composition (PC) can be used for the production of a moulded article, wherein the polymer composition (PC) is formed.

Therefore, a further object of the present invention is a process for the production of a moulded article by forming the polymer composition (PC). Another object of the present invention is a moulded article comprising the polymer composition (PC).

The fibres (B) comprised in the obtained polymer composition (PC) increase the toughness and/or reinforcement of the moulded articles made from said polymer composition (PC).

Thus, a further object of the present invention is the use of fibres (B), having a fibre length l, in a polymer composition (PC) comprising at least one thermoplastic polymer (A) for increasing the toughness and/or reinforcement of moulded articles made from said polymer composition (PC), wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm.

The invention is elucidated in detail by examples hereinafter, without restricting it thereto.

### EXAMPLES

The following components were employed:

Thermoplastic polymer (A):

| | | |
|---|---|---|
| (A1) | Polyamide 6 (PA 6) | (Ultramid ® B27E; BASF SE) |

Fibres (B):

| | | |
|---|---|---|
| (B'1) | Glass fibres 400 μm | (Glass fibre roving (TufRov 4510, 12 μm, 1200tex, Nippon |
| | | Electric Glass), cut to length 400 um) |
| (B'2) | Glass fibres 450 μm | (Glass fibre roving (TufRov 4510, 12 μm, 1200tex, Nippon |
| | | Electric Glass), cut to length 450 um) |
| (B'3) | Short glass fibre | (T249H, 12 μm, 4.5 mm length, Nippon Electric Glass) |

Additive (C):

| | | |
|---|---|---|
| (C1) | Irganox B1171 | (BASF SE) |
| (C2) | Licowax C | (Clariant SE) |

Table 1 states the essential parameters of the thermoplastic polymer used (component (A)).

TABLE 1

| | | | | | | Zero shear rate |
|---|---|---|---|---|---|---|
| | | | | | | viscosity η₀ at |
| | | AEG | CEG | T_{M} | T_{G} | 240° C. |
| | Type | [mmol/kg] | [mmol/kg] | [° C.] | [° C.] | [Pas] |
| (A1) | PA 6 | 36 | 54 | 220.0 | 53 | 399 |

### Measurement of the Fibre Length Distribution:

Before measuring the fibre length distribution, the samples were ashed at 650° C. for 1 to 2 hours.

The fibre length distribution was determined according to the following method:

In order to avoid fibre breakage and frit abrasion, from the fibres a spatula tip was carefully removed and transferred to a glass bottle. 1 to 2 drops of glycerin were added (as a de-wetting agent) and the glass bottle was filled up to approximately 100 mL with deionized water and well shaken. In the meantime, the homogeneous distribution of the fibres was visually checked for. The mixture was quickly transferred into a Petri dish in the scanner support so that the bottom of the Petri dish was covered with sufficient liquid (approximately half full). The Petri dish was filled without refilling as mainly small fibres are transferred during refilling, wherein the fibre distribution changes. Before taking a picture, 1 minute was waited until all fibres have really settled. The fibre distribution and quantity was visually checked.

Production of Fibres with Defined Fibre Length l:

The glass fibre roving specified above was cut to fibres having a defined fibre length l with a guillotine cutting machine P26 from Pierret Industries (Belgium).

Table 2 states the produced samples:

TABLE 2

| | B′1 | B′2 |
|---|---|---|
| Fibre length I | 400 | 450 |
| [μm] | | |
| Cuts/min | 150 | 150 |
| Ventilation | No | Yes |
| Cable | Yes | Yes |
| Cutting angle | 37 | 37 |
| [°] | | |
| Counter angle | 20 | — |
| [°] | | |
| dry/wet | dry | dry |

### Production of the Polymer Composition (PC)

The quantities of polyamide (component (A)) and glass fibres (component (B′)) given in table 3 were compounded and then pelletized using a ZSK25 twin-screw extruder (configuration S1) at 150 rpm with a barrel temperature of 270° C. and a throughput of 6 kg/h.

TABLE 3

| | I1 | C1 |
|---|---|---|
| A1 | 69.3 | 69.3 |
| [% by weight] | | |
| B′3 | — | 30 |
| [% by weight] | | |
| B′1 | 30 | — |
| [% by weight] | | |
| C1 | 0.2 | 0.2 |
| [% by weight] | | |
| C2 | 0.5 | 0.5 |
| [% by weight] | | |

The quantities of polyamide (component (A) and glass fibres (component (B′) given in table 4 were compounded and then pelletized using a ZE25 twin screw extruder (configuration G84) at 270 rpm with a barrel temperature of 270° ° C. and a throughput of 10 kg/h.

TABLE 4

| | I2 |
|---|---|
| A1 | 69.3 |
| [% by weight] | |
| B′2 | 30 |
| [% by weight] | |
| C1 | 0.2 |
| [% by weight] | |
| C2 | 0.5 |
| [% by weight] | |

The fibre length distribution of the samples was then measured as described. The results are shown in table 5.

TABLE 5

| | I1 | I2 | C1 |
|---|---|---|---|
| Variance | 10 | 10 | 10 |
| [%] | | | |
| Maximum | 376 | 429 | 344 |
| [μm] | | | |
| Amount of fibres having the | 60 | 47 | 19 |
| maximum length | | | |
| [% by weight] | | | |
| Amount of fibres having a fibre | 4 | 2 | 4 |
| length < 100 μm | | | |
| [% by weight] | | | |
| Amount of fibres having a fibre | 10 | 9 | 15 |
| length < 200 μm | | | |
| [% by weight] | | | |

1. A polymer composition (PC) comprising the following components (A) and (B)
(A) at least one thermoplastic polymer and
(B) fibres having a fibre length 1,
wherein at most 10% by weight of the fibres (B), based on the total weight of the fibres (B), have a fibre length 1 of less than 100 μm, and at most 12% by weight of the fibres (B), based on the total weight of the fibres (B), have a fibre length 1 of less than 200 μm,
wherein from 1 to 10% by weight of the fibres (B), based on the total weight of the fibres (B), have a fibre length 1 of less than 100 μm, and from 1 to 12% by weight of the fibres (B), based on the total weight of the fibres (B), have a fibre length 1 of less than 200 μm,
wherein the polymer composition (PC) comprises in the range of from 50 to 75% by weight of component (A) and in the range of from 25 to 50% by weight of component (B), based in each case on the total weight of the polymer composition (PC), and
wherein the at least one thermoplastic polymer (A) is a polyamide selected from the group consisting of polyamide 6 (PA 6), polyamide 66 (PA 66), polyamide 6/66 (PA 6/66), polyamide 66/6 (PA 66/6), polyamide 610 (PA 610), polyamide 6/6T (PA 6/6T), polyamide 6T/6I (PA 6T/61), polyamide 12 (PA 12), polyamide 4T (PA 4T), polyamide 9T (PA 9T), polyamide 46 (PA 46), polyamide 1010 (PA 1010) and polyamide 1212 (PA 1212).

2. The polymer composition (PC) according to claim 1, wherein at most 5% by weight of the fibres (B), based on the total weight of the fibres (B), have a fibre length l of less than 100 pm.

3. The polymer composition (PC) according to claim 1, wherein the fibres (B) have a monomodal fibre length distribution with a maximum (M), wherein the maximum (M) is a value (V) in the range of from 200 to 600 pm, wherein at least 35% by weight of the fibres (B), based on the total weight of the fibres (B), have a fibre length l of this value (V) with a standard deviation of ±0.1×I.

4. The polymer composition (PC) according to claim 1, wherein the fibres (B) have a monomodal fibre length distribution with a maximum (M), wherein the maximum (M) is a value (V) in the range of from 200 to 600 pm, wherein at least 50% by weight of the fibres (B), based on the total weight of the fibres (B), have a fibre length l of this value (V) with a standard deviation of ±0.25×I.

5. The polymer composition (PC) according to claim 1, wherein the fibres (B) are
i) selected from the group consisting of glass fibres, basalt fibres, carbon fibres, metal fibres and plastic fibres, and/or
ii) selected from the group consisting of hollow fibres and flat fibres.

6. The polymer composition (PC) according to claim 5, wherein the glass fibres have a diameter in the range of from 5 to 30 pm.

7. The polymer composition (PC) according to claim 1, wherein the polymer composition (PC) further comprises at least one additive (C) selected from the group consisting of stabilizers, dyes, pigments and plasticizers.

8. The polymer composition (PC) according to claim 1, wherein from 1 to 5% by weight of the fibres (B), based on the total weight of the fibres (B), have a fibre length l of less than 100 μm, and from 1 to 12% by weight of the fibres (B), based on the total weight of the fibres (B), have a fibre length l of less than 200 μm.

9. A process for producing a polymer composition (PC) according claim 1 comprising the following steps a) and b)
a) providing fibres (B′) having a defined fibre length l1 in the range of from 200 to 600 μm, and
b) compounding the fibres (B′) with at least one thermoplastic polymer (A) in an extruder, wherein the polymer composition (PC) comprising the at least one thermoplastic polymer (A) and the fibres (B) having a fibre length l is obtained, wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm,
wherein from 1 to 10% by weight of the fibres (B), based on the total weight of the fibres (B), have a fibre length l of less than 100 μm, and from 1 to 12% by weight of the fibres (B), based on the total weight of the fibres (B), have a fibre length l of less than 200 μm.

10. The process according to claim 9, wherein the fibres (B′) are provided by cutting a fibre roving (R) into fibres (B′).

11. A process for producing a moulded article, the process comprising forming the moulded article with the polymer composition (PC) of claim 1.

12. A moulded article comprising the polymer composition (PC) according to claim 1.

13. A method of using fibres (B), having a fibre length l, in a polymer composition (PC) comprising at least one thermoplastic polymer (A), the method comprising using the fibres (B) for increasing the toughness and/or reinforcement of moulded articles made from said polymer composition (PC), wherein at most 10% by weight of the fibres (B), based on the total weight of the fibres (B), have a fibre length l of less than 100 μm, and at most 12% by weight of the fibres (B), based on the total weight of the fibres (B), have a fibre length l of less than 200 μm,
wherein from 1 to 10% by weight of the fibres (B), based on the total weight of the fibres (B), have a fibre length l of less than 100 μm, and from 1 to 12% by weight of the fibres (B), based on the total weight of the fibres (B), have a fibre length l of less than 200 μm,
wherein the polymer composition (PC) comprises in the range of from 50 to 75% by weight of component (A) and in the range of from 25 to 50% by weight of component (B), based in each case on the total weight of the polymer composition (PC), and
wherein the at least one thermoplastic polymer (A) is a polyamide selected from the group consisting of polyamide 6 (PA 6), polyamide 66 (PA 66), polyamide 6/66 (PA 6/66), polyamide 66/6 (PA 66/6), polyamide 610 (PA 610), polyamide 6/6T (PA 6/6T), polyamide 6T/6I (PA 6T/61), polyamide 12 (PA 12), polyamide 4T (PA 4T), polyamide 9T (PA 9T), polyamide 46 (PA 46), polyamide 1010 (PA 1010) and polyamide 1212 (PA 1212).

14. (canceled)

15. (canceled)

16. (canceled)

17. (canceled)

18. The polymer composition (PC) according to claim 1, wherein the fibres (B) are
i) selected from the group consisting of E-glass fibres, S-glass fibres, R-glass fibres, M-glass fibres, C-glass fibres, ECR-glass fibres, D-glass fibres, AR-glass fibres and Q-glass fibres, and/or
ii) selected from the group consisting of hollow fibres and flat fibres.
